(19) United States
(12) Patent Application Publication
(10) Pub. No.: US 2002/0077075 A1
(43) Pub. Date: Jun. 20, 2002

(54) Method and apparatus for providing emergency position report

(75) Inventors: Marko Kalevl Ikonen, Oulu (FI); Petri Juhani Katekeetta, Oulu (FI)

Correspondence Address: HARRINGTON & SMITH, LLP, 1809 BLACK ROCK TURNPIKE, FAIRFIELD, CT, 06432, US

(73) Assignee: NOKIA MOBILE PHONES LTD.

(21) Appl. No.: 09/741,231

(22) Filed: Dec. 20, 2000

(51) Int. Cl. H04M 11/00

(52) U.S. Cl. 455/404; 455/456; 455/434

(57) ABSTRACT

A wireless communications system includes a mobile station and a wireless network, where the system enables the transmission of emergency position information from the mobile station to the wireless network. The mobile station includes circuitry, such as a suitably programmed data processor and a transmitter, for initiating the origination of an emergency call and for determining position information that is descriptive of a current position of the mobile station. The mobile station further includes circuitry for transmitting, as a part of the emergency call procedure, the determined position information to the wireless network using any available type of channel. The wireless network includes circuitry, such as a suitably programmed data processor and a receiver, for recognizing a receipt of the determined position information from different types of channels. The determined position information can be transmitted using a Digital Control Channel or an Analog Control or Voice Channel. The determined position information may instead be transmitted using a Digital Traffic Channel, and in this case the mobile station is responsive to an indication that the position information was not received by the wireless network for re-transmitting the position information using a Digital Control Channel. The position information may be transmitted prior to the start of the emergency call on an assigned control channel. The position information can include latitude and longitude, or it may include GPS measurement data. A method for operating the wireless communication system is also disclosed.

### FIELD OF THE INVENTION

This invention relates generally to wireless communications systems and, more particularly, to wireless communications systems wherein a mobile terminal or station has the ability to provide position location information to a network.

### BACKGROUND OF THE INVENTION

An Emergency Position Report procedure has been specified in TIA/EIA, Revision C for use by a mobile station, whereby when a user dials an emergency number (i.e., a 911 operator) the mobile station automatically sends an Emergency Position Report message on the assigned Digital Traffic Channel (DTC).

More particularly, as defined in a document entitled TR45, SP-4027-740 Draft Text, TDMA Third Generation Wireless System Assisted Mobile Positioning Through Satellite (SAMPS) Teleservice, Jul. 21, 2000, Section 2.6, Emergency Position Report Procedure (page 9), the mobile station may include Position Information or Global Positioning System (GPS) Measurement Data in the Emergency Position Report message. As defined, the mobile station “shall only send this message on the assigned DTC”.

The inventors have recognized that this procedure, as presently defined, is flawed, as there may arise situations where the user terminates the call early (either intentionally or unintentionally), or where the call is dropped by the network. In these cases the Emergency Position Report message may not be sent to the network, resulting in the position of the user not being known, or only being known imprecisely (e.g., within a particular cell).

### OBJECTS AND ADVANTAGES OF THE INVENTION

It is a first object and advantage of this invention to provide an improved emergency position reporting procedure that overcomes the foregoing and other problems.

It is a further object and advantage to provide an emergency position reporting procedure wherein a user's position information can be sent over a channel other than just the DTC.

It is another object and advantage of this invention to provide an emergency position reporting procedure wherein an Emergency Position Report message may be sent on a Digital Control Channel (DCCH), or on some other channel, such as an Analog Control Channel (ACC), or an Analog Traffic Channel, typically referred to as an Analog Voice Channel (AVC).

### SUMMARY OF THE INVENTION

The foregoing and other problems are overcome and the foregoing objects and advantages are realized by methods and apparatus in accordance with embodiments of this invention.

A wireless communications system includes a mobile station and a wireless network, where the system enables the transmission of emergency position information from the mobile station to the wireless network. The mobile station includes circuitry, such as a suitably programmed data processor and a transmitter, for initiating the origination of an emergency call and for determining position information that is descriptive of a current position of the mobile station. The mobile station further includes circuitry for transmitting, as a part of the emergency call, the determined position information to the wireless network using any available type of channel. The wireless network includes circuitry, such as a suitably programmed data processor and a receiver, for recognizing a receipt of the determined position information from different types of channels. The determined position information can be transmitted using a Digital Control Channel or an Analog Control or Voice Channel. The determined position information may instead be transmitted using a Digital Traffic Channel, and in this case the mobile station is responsive to an indication that the position information was not received by the wireless network for re-transmitting the position information using a Digital Control Channel. The position information may be transmitted prior to the start of the emergency call on a control channel. The position information may be transmitted on any available channel after the call is dropped. The position information can include latitude and longitude, or it may include GPS measurement data. The position information can also include an identification of the mobile station. A method for operating the wireless communication system is also disclosed.

Also disclosed is a method to transmit emergency position information from the mobile station to the wireless network that allows a current position of the mobile station to be tracked. This method includes steps of initiating the origination of an emergency call; determining, in the mobile station, position information that is descriptive of a current position of the mobile station; as a part of an emergency call procedure, transmitting the determined position information to the wireless network using any available type of channel; and repeating the steps of determining and transmitting at least once. The step of repeating may be terminated in response to a predetermined message received from the wireless network.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is block diagram of a mobile station and a wireless network that is suitable for practicing this invention;

FIG. 2 is a signal flow diagram between the mobile station and the wireless network in accordance with a first embodiment of this invention;

FIG. 3 shows the transmission of the Emergency Position Message as an R-Data message, and the R-Data Acknowledgment (ACK) from the network;

FIG. 4A is a logic flow diagram showing the operation of the mobile station when the R-Data ACK is not received;

FIG. 4B is a logic flow diagram showing the operation of the mobile station when the R-Data ACK is not received, and for a case where the call is switched from a DTC to an AVC before the call has ended;

FIG. 5A is a signal flow diagram between the mobile station and the wireless network in accordance with a second embodiment of this invention;

FIG. 5B is a signal flow diagram between the mobile station and the wireless network in accordance with a third embodiment of this invention; and

FIG. 6 is a signal flow diagram between the mobile station and the wireless network showing a common case where a call is initiated normally, the position location is in progress when the call is dropped, and the mobile station position is then sent to the network using a DCCH.

### DETAILED DESCRIPTION OF THE INVENTION

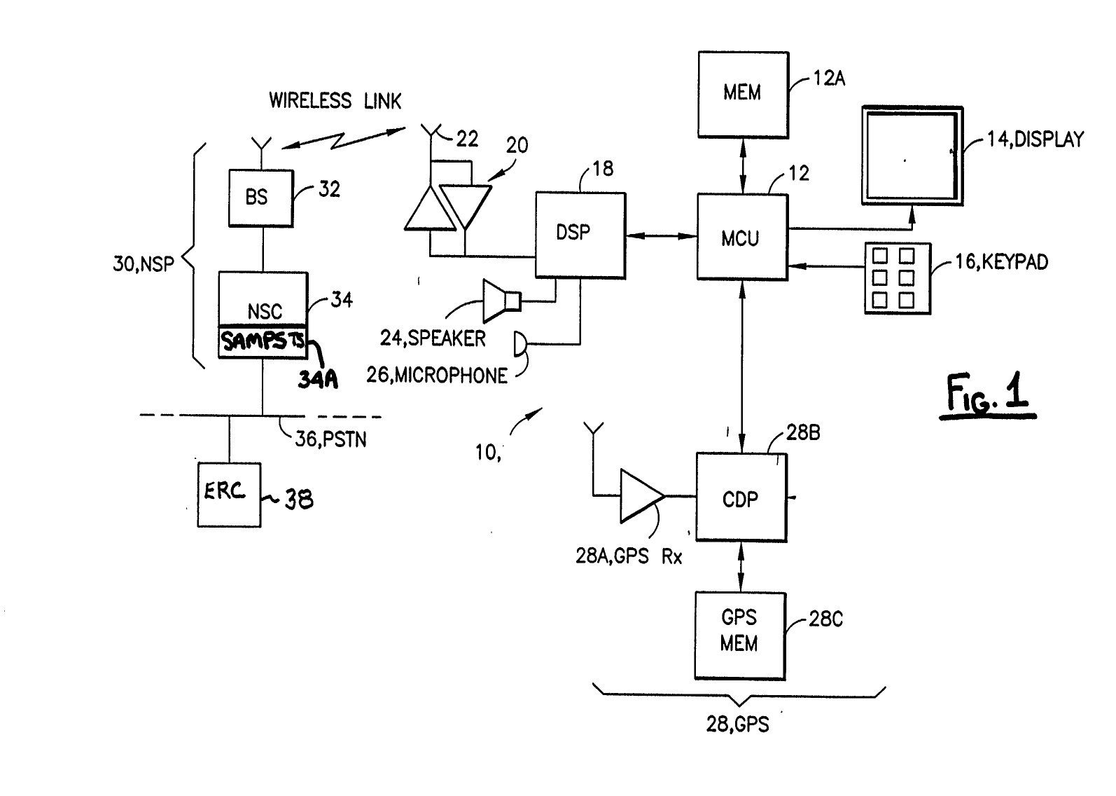

FIG. 1 is a simplified block diagram of a mobile station (MS) 10 that incorporates or is coupled to a GPS accessory or sub-system 28. The MS 10 contains a data processor such as a microprocessor control unit (MCU) 12 that is coupled to a visual display 14, such as a LCD, and that receives input from a keypad 16. The keypad 16 may contain alphanumeric keys, soft keys, a power on/off key, etc., as is conventional in these types of devices. The combination of the MCU 12, display 14 and keypad 16 provides the user interface (UI) of the MCT 10. A memory (MEM) 12A stores an operating program for the MCU 12, as well as user entered data and other data and constants. The memory 12A is also assumed to store programming instructions that implement the teachings of this invention.

The MS 10 may also include a digital signal processor (DSP) type of device 18 that implements the required baseband and audio functions. A radio frequency (RF) transceiver 20 is bidirectionally coupled to the DSP 18, as well as to at least one antenna 22. A speaker 24 (or earphone) and a microphone 26 are typically also coupled to the DSP 18 for enabling a user to make and receive telephone voice calls.

Using the transceiver 20 and antenna 22 the MS 10 is enabled to establish bidirectional communication links with remote transceivers, and to gain access to voice and data communication networks. To this end there exists at least one network service provider (NSP) 30 operating at least one base site or station (BS) 32 coupled to a Network Service Center (NSC) 34. The NSC 34 may be coupled directly or indirectly to a telecommunications network such as the Public Switched Telephone Network (PSTN) 36. Coupled to the PSTN 36 is at least one emergency response center (ERC) 38 that can be reached from the MS 10 by dialing an emergency number, such as 911. The NSP 30 is assumed to include a SAMPS Teleservice (TS) 34A or equivalent function.

The GPS accessory or sub-system 28 includes a GPS antenna and receiver 28A, a controlling data processor (CDP) 28B and required support circuitry, and a memory 28C for storing an operating program and data, such as satellite orbital parameters needed for acquiring transmissions from the satellites of the GPS constellation (not shown).

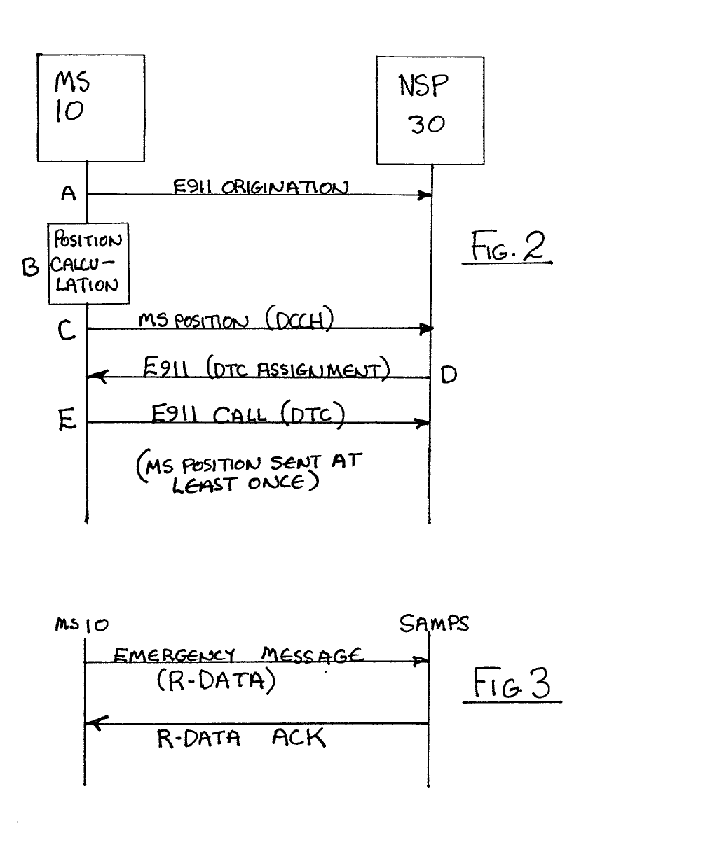

In accordance with an aspect of this invention the MCU 12 is responsive to position information (e.g., latitude, longitude, and possibly elevation) received from the CDP 28B for transmitting the position information to the NSC 34 via the BS 32. The position information is transmitted using, preferably, a Digital Control Channel (DCCH)during an emergency call establishment procedure (before arrow D in FIG. 2). The position information may be sent to the ERC 38. In other embodiments of the invention other channels could be used to transmit the position information, such as Analog Control Channel or an Analog Voice Channel.

In general, the DTC is used during the call to send the mobile station position information, and the DCCH after the call is dropped. By “dropped” what is meant herein is the case where the network terminates the call for whatever reason (e.g., the presence of strong interference or a weak signal from the mobile station), as well as the case where the user either intentionally or unintentionally terminates the call prematurely. A dropped call in the context of this invention also includes a case wherein the network terminates a call on a DTC, and switches the call to an AVC.

In the preferred case, if the position is calculated before the assignment of a DTC to the mobile station 10 (in some cases it can be calculated even before E911 call origination), the position information can be sent using the DCCH. If the call is active when the position calculation completes, the calculated position can be sent using the DTC. If the call is dropped before the calculation is completed, the position is transmitted using the DCCH after the call.

By using the DCCH in addition to the DTC the probability is increased that the position information will reach the NSP 30. That is, since the MS 10 is not required to wait until it is assigned a DTC for the emergency call, which may not be available, or which may be prematurely terminated (dropped) during the call, the emergency position information can be more reliably delivered to the intended recipient of this information.

In other embodiments of this invention the MS 10 may not include or be coupled to the GPS system 28, and may determine the location or position of the MS 10 using some other source of position data. For example, in one embodiment the MS 10 may calculate its position using information received from the NSC 34, via the BS 32, or information received from the BS 32.

In some embodiments of the invention the MS 10 may not calculate its own position, but may instead transmit the GPS Measurement Data to the NSP 30. In this case the position of the MS 10 can be calculated by a data processor that is external to the MS 10, such as by a data processor that is associated with the SAMPS TS 34A.

Reference is made to FIG. 2 for showing a signal flow diagram representing signal flow between the MS 10 and the NSP 30 in accordance with a first embodiment of this invention. At Step A it is assumed that the MS 10 has originated an emergency call on a control channel (e.g., a DCCH). The emergency call can be initiated either in response to input from a user or automatically based on some condition or conditions being fulfilled. Step B, which may follow immediately after Step A, the MS 10 begins the position calculation based on GPS measurement data received from the GPS system 28, which information may need to be first acquired by the GPS system 28 from the satellites of the GPS constellation. This step may take some number of seconds or even tens of seconds to execute. At Step C the MS 10 transmits the calculated MS 10 position using the DCCH (not the DTC as is specified by the prior art.) The MS position can be transmitted as an Emergency Position Report Message. At Step D the NSP 30 returns an E911 traffic channel assignment (e.g., a DTC assignment). At Step E the MS 10 transitions to the assigned DTC to make the E911 call to the ERC 30 (see FIG. 1). By this time, however, the MS position information has already been sent over the DCCH. As such, even if the E911 call is terminated or dropped, the location of the MS 10, and thus the location of the user, is known to the ERC 38.

Note can be made that a timer between Step A and Step D is about 12.8 seconds. If the result of the position calculation is ready in that time then it can be sent on the DCCH. The timer between Steps D and E is about 100 milliseconds (the time when the mobile station 10 must start the E911 call on the DTC).

In other embodiments the Emergency Position Report Message can be sent over any available channel, such as an ACC or an Analog Voice Channel (if available).

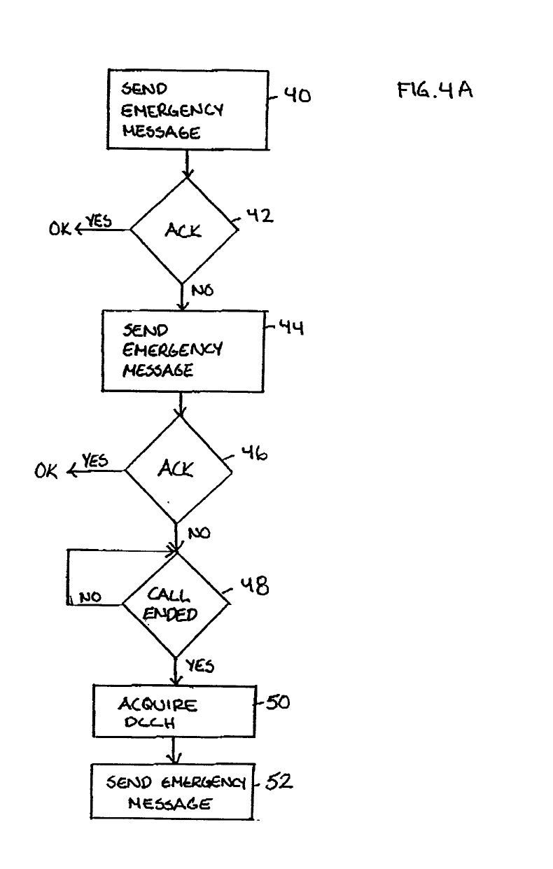

FIG. 3 shows the transmission of the Emergency Position Report Message as an R-Data message, and the R-Data Acknowledgment (ACK) from the NSP 30 for indicating successful receipt of the R-Data message.

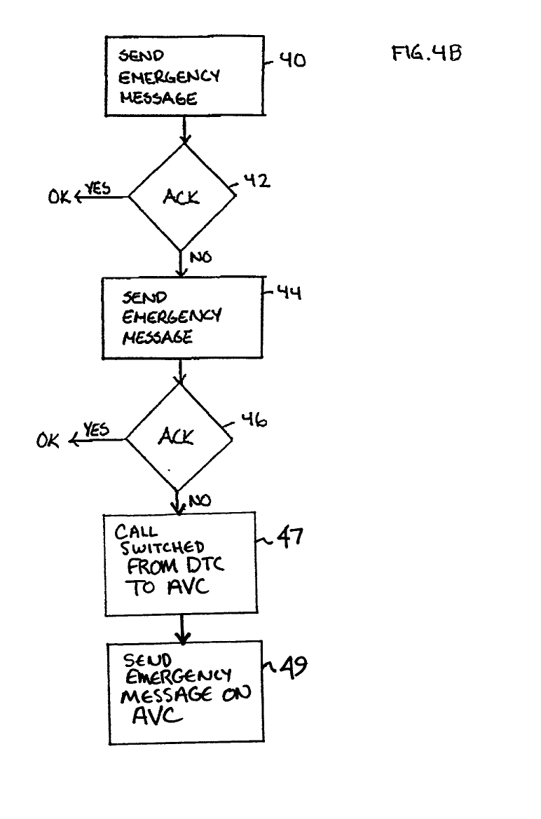

FIG. 4A is a logic flow diagram showing the operation of the MS 10 when the R-Data ACK is not received, after the Emergency Position Report Message is transmitted over the DTC. At Step 40 the MS 10 transmits the Emergency Position Report Message over the DTC, and at Step 42 determines if the R-Data ACK has been received. If it is, processing continues in a normal fashion. If the R-Data ACK is not received, then a retry is performed, and at Step 44 the MS 10 again transmits the Emergency Position Report Message over the DTC. At Step 46 the MS 10 determines if the R-Data ACK has been received. If it has, processing continues in a normal fashion. If the R-Data ACK is not received, then the MS 10 waits at Step 48 until the call is terminated (on the currently assigned DTC) and acquires the DCCH (if not already acquired), at Step 50 the mobile station 10 acquires a DCCH, and at Step 52 the MS 10 again transmits the Emergency Position Report Message, but this time over the DCCH.

FIG. 4B shows the case where the call is switched from a DTC to an AVC before the call has ended. (Step 47). In this case the MS 10 may transmit the Emergency Position Report on the assigned AVC (Step 49).

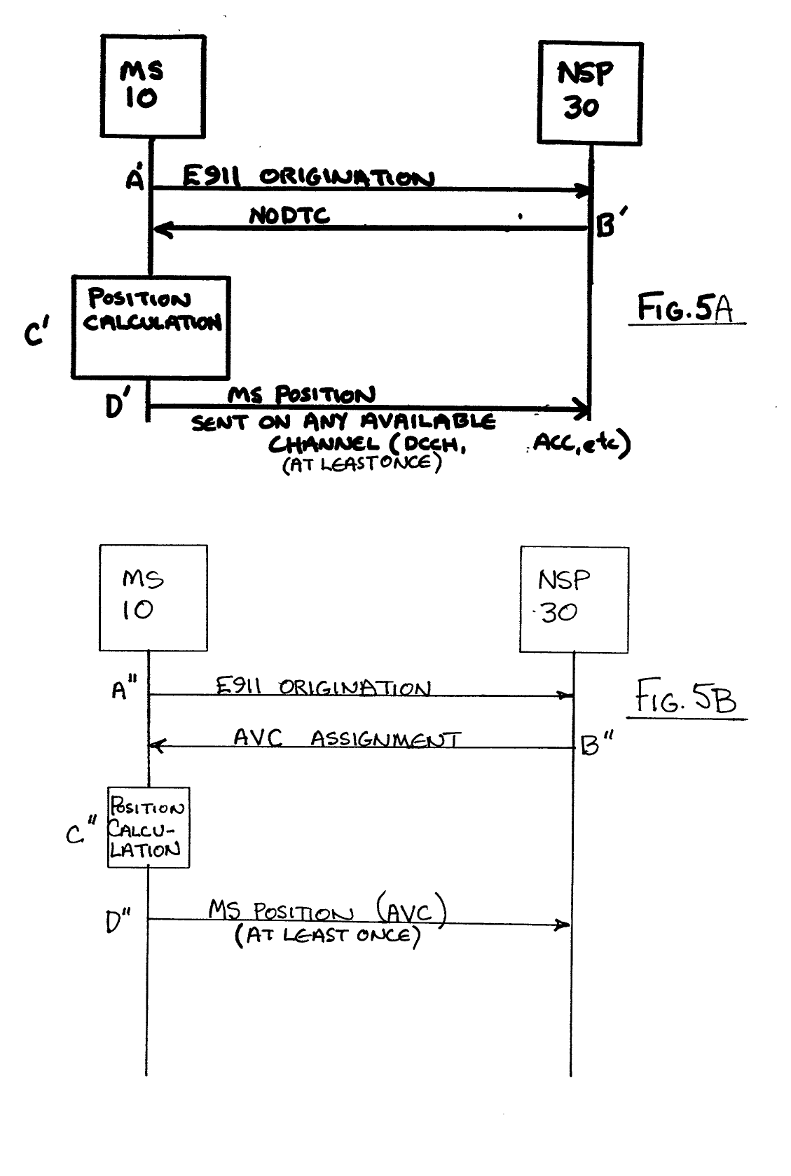

FIG. 5A is a signal flow diagram showing signal flow between the MS 10 and the NSP 30 in accordance with a second embodiment of this invention. In this case the at Step A′ the MS 10 transmits the E911 call origination message over the DCCH in the same manner as described above with respect to Step A of FIG. 2. However, it is assumed that at Step B′ the NSP 30 transmits a message indicating that there is no DTC available to be assigned to the MS 10. During this time the MS 10 has started the position calculation (Step C′), which may take some period of time to complete (e.g., the GPS system 28 may obtain measurement data from the GPS satellite constellation, which is then operated on by the CDP 28B to determine the current position of the MS 10). At the completion of the position calculation step C′ the MS 10 transmits the position information (or just the GPS Measurement Data in some embodiments) using whatever channel is currently available. For example, if there is still no DTC assigned, then the position information is sent on the DCCH. If the DTC was assigned in the interim, then the DTC can be used and, if the R-Data ACK is not received, then the MS 10 can revert to using the DCCH as in FIG. 4. Alternatively, and if some other channel type is available, such as an Analog Control Channel or an Analog Voice Channel, then the available other type of channel is used to transmit the MS position information.

Further in this regard, and by example, FIG. 5B shows a signal flow diagram between the MS 10 and the NSP 30 in accordance with a further embodiment of this invention. At Step A″ the MS 10 transmits the E911 call origination message over the DCCH in the same manner as described above with respect to Step A of FIG. 2 and Step A′ of FIG. 5A. At Step B″ the NSP 30 transmits a message assigning, instead of a DTC, an AVC. During this time the MS 10 has started the position calculation (Step C″). At the completion of the position calculation step C″ the MS 10 transmits the position information (or just the GPS Measurement Data in some embodiments) using the assigned AVC.

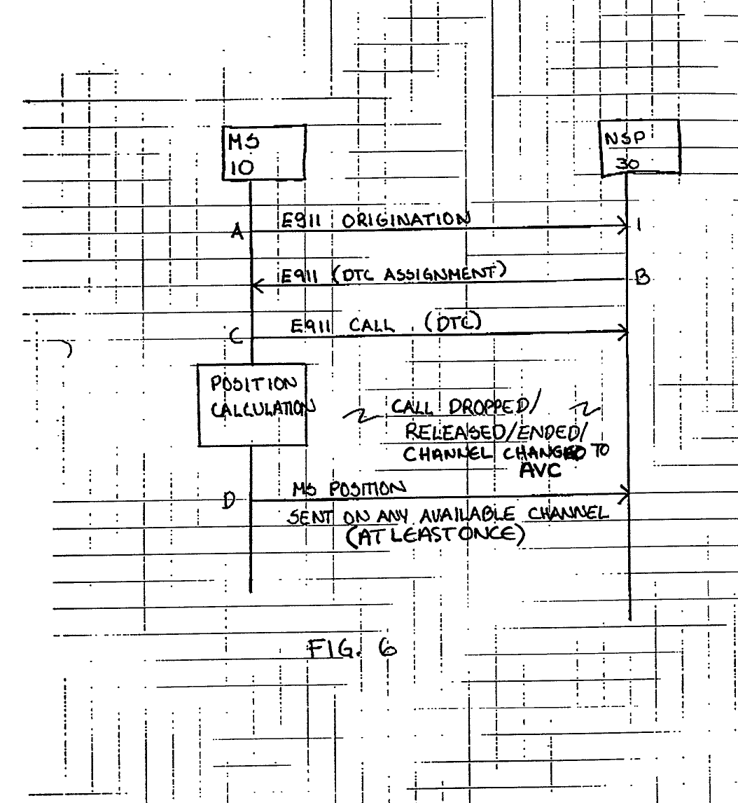

Reference is now made to the signal flow diagram of FIG. 6 for showing yet another embodiment of these teachings.

At Step A the mobile station 10 originates an E911 emergency call, and at Step B the NSP 30 assigns a DTC for the E911 call. At Step C the mobile station 10 starts the E911 call on the assigned DTC and also initiates the position calculation. While the position calculation is in progress the E911 call is dropped or released or ended or is switched to an AVC. At Step D the result of the position calculation sent from the mobile station 10 to the NSP 30 over any available channel (DCCH, ACC, AVC, etc.)

As currently described the Emergency Position Report is transmitted once, even if the user moves. However, it is also within the scope of these teachings to calculate the MS position and to transmit the Emergency Position Report message more than once. This mode of operation enables the position of the user to be tracked over time by sending at least two Emergency Position Report messages on the assigned DTC, or on any available channel (e.g., DCCH, ACCH, AVC). This provides an improved user security function. For example, the user may be experiencing some medical distress while riding on a train, or the user may be walking or driving in an attempt to locate medical assistance.

In this embodiment a new Information Element (IE) is preferably specified for use in the Emergency Position Report message (TIA/EIA-136-740 3.2.8), such as, by example only, “multiple emergency position reports (first/second, . . . , last)”, or “multiple emergency position reports (x of y)”, where x≦y, whereby the MS 10 is enabled to specify that it will be sending multiple Emergency Position Reports, and may possibly indicate how many will be sent. In this embodiment the network may also be provided with suitable forward link signaling for instructing the MS 10 to terminate the sending of multiple Emergency Position Report messages.

It should be pointed out that while the mobile station position calculation block has been shown at various locations in the signal flow diagrams that, in actuality, the position calculation starts right after the E911 call origination and proceeds in parallel with the signal flow indicated by the other arrows. The position calculation may have also been started prior to E911 call origination for some other purpose. In this case the position calculation is preferably not restarted after the E911 call origination.

By the use of these teachings it can be appreciated that the probability of getting the MS position information through to the ERC 38 is improved over the prior art case, wherein only the DTC is specified for use.

It should be noted that while the operating software of the MS 10 is modified to be compatible with these teachings, the operating software of the NSP 30 is modified as well so as to recognize the receipt of the Emergency Position Report Message on a channel other than the DTC.

While the invention has been particularly shown and described with respect to preferred embodiments thereof, it will be understood by those skilled in the art that changes in form and details may be made therein without departing from the scope and spirit of the invention.

What is claimed is:

1. A method to transmit emergency position information from a mobile station to a wireless network, comprising steps of:
initiating the origination of an emergency call;
determining at least once in the mobile station position information that is descriptive of a current position of the mobile station; and
as a part of an emergency call procedure, transmitting the determined position information to the wireless network using any available type of channel.

2. A method as in claim 1, wherein the determined position information is transmitted using a Digital Control Channel.

3. A method as in claim 1, wherein the determined position information is transmitted using a Digital Traffic Channel, and further comprising a step, executed in response to an indication that the position information was not received by the wireless network, re-transmitting the position information using a Digital Control Channel.

4. A method as in claim 1, wherein the determined position information is transmitted using an Analog Control Channel.

5. A method as in claim 1, wherein the determined position information is transmitted using an Analog Voice Channel.

6. A method as in claim 1, wherein the position information is comprised of latitude and longitude.

7. A method as in claim 1, wherein the position information is comprised of GPS measurement data.

8. A method as in claim 1, wherein the position information is transmitted prior to the start of the emergency call on an assigned control channel.

9. A method as in claim 1, wherein the position information is transmitted after the emergency call is dropped.

10. A wireless communications system comprising a mobile station and a wireless network, said system enabling a transmission of emergency position information from said mobile station to said wireless network, said mobile station comprising circuitry for initiating the origination of an emergency call and a processor for determining, at least once, position information that is descriptive of a current position of the mobile station, said mobile station further comprising circuitry for transmitting, as a part of an emergency call procedure, the determined position information to the wireless network using any available type of channel; and said wireless network comprising circuitry for recognizing a receipt of the determined position information from different types of channels.

11. A system as in claim 10, wherein the determined position information is transmitted using a Digital Control Channel.

12. A system as in claim 10, wherein the determined position information is transmitted using a Digital Traffic Channel, and wherein said mobile station is responsive to an indication that the position information was not received by the wireless network, for retransmitting the position information using a Digital Control Channel.

13. A system as in claim 10, wherein the determined position information is transmitted using an Analog Control Channel.

14. A system as in claim 10, wherein the determined position information is transmitted using an Analog Voice Channel.

15. A system as in claim 10, wherein the position information is comprised of latitude and longitude.

16. A system as in claim 10, wherein the position information is comprised of GPS measurement data.

17. A system as in claim 10, wherein the position information is transmitted prior to the start of the emergency call on an assigned voice channel.

18. A system as in claim 10, wherein the position information is transmitted after the emergency call is dropped.

19. A method to transmit emergency position information from a mobile station to a wireless network, comprising steps of:
determining, in the mobile station, position information that is descriptive of a current position of the mobile station;
initiating the origination of an emergency call; and
as a part of an emergency call procedure, transmitting the determined position information to the wireless network using any available type of channel.

20. A method as in claim 19, wherein the determined position information is transmitted using a Digital Control Channel.

21. A method as in claim 19, wherein the position information is transmitted prior to the start of the emergency call on an assigned control channel.

22. A method as in claim 19, wherein the position information is transmitted after the emergency call is dropped.

23. A method to transmit emergency position information from a mobile station to a wireless network, comprising steps of:
initiating the origination of an emergency call;
determining, in the mobile station, position information that is descriptive of a current position of the mobile station;
as a part of an emergency call procedure, transmitting the determined position information to the wireless network using any available type of channel; and
repeating the steps of determining and transmitting at least once.

24. A method as in claim 23, wherein the step of repeating is terminated in response to a predetermined message received from the wireless network.
